(19) United States
(12) Patent Application Publication
(10) Pub. No.: US 2014/0000425 A1
(43) Pub. Date: Jan. 2, 2014

(54) CUTTER BLADE AND METHOD MAKING AND USING THE SAME

(71) Applicant: H.J. HEINZ COMPANY, Pittsburgh, PA (US)

(72) Inventors: Brian HUBER, Pittsburgh, PA (US); Craig DOAN, Weiser, ID (US); Tamra DOBLER, Fruitland, ID (US)

(21) Appl. No.: 13/929,177

(22) Filed: Jun. 27, 2013

Related U.S. Application Data
(60) Provisional application No. 61/666,534, filed on Jun. 29, 2012.

(51) Int. Cl. B26D 1/25

(52) U.S. Cl. CPC B26D 1/25
USPC 83/13; 83/651; 83/663

(57) ABSTRACT

Cutter blade is a generally elongate member having an undulating portion, a leading edge, a trailing edge, and a width defined by a distance between the leading edge and the trailing edge when viewed from a first side surface. At least a section of the width of the undulating portion located behind the leading edge has a generally uniform thickness. A method of slicing a food product includes mounting at least one cutter blade of any of the types described above on a device that rotates and rotating the at least one cutter about a center axis of the device that rotates. A method of assembling a device for slicing a food product includes mounting at least one cutter blade on a rotating portion of the device.

### CROSS-REFERENCE TO RELATED APPLICATIONS

The instant application claims the benefit under 35 U.S.C. §119(e) of U.S. Provisional Application No. 61/666,534 filed Jun. 29, 2012, the disclosure of which is hereby expressly incorporated by reference hereto in its entirety.

### BACKGROUND OF THE INVENTION

1. Field of the Invention

The invention relates to a cutter blade in which a generally elongate member utilizes an undulating portion, a leading edge and a trailing edge and wherein at least a section of the width of the undulating portion located behind or adjacent the leading edge has a generally uniform thickness. The invention also relates to a method of slicing a food product utilizing the cutter blade as well as method of assembling a device for slicing a food product which includes mounting the cutter blade.

2. Discussion of Background Information

Food product slicers are typically used to efficiently slice food products meeting certain specifications such as slice thickness and texture. Conventional slicers include those described in U.S. Pat. No. 6,148,702 to BUCKS, U.S. Pat. No. 6,973,862 to BUCKS, U.S. Pat. No. 7,000,518 to BUCKS et al. and U.S. Pat. No. 7,721,637 to BUCKS, the entire disclosure of each of these documents is hereby expressly incorporated by reference. A commercial embodiment of such a slider is known as the TranSlicer 2000 made by Urschel Laboratories, Inc. described at http://www.urschel.com/f8018ae891_sites/urschel.com/files/ts2000cpage1.pdf, the entire disclosure of this document is hereby expressly incorporated by reference. Such devices typically include a rotating device such as a wheel to which is mounted a plurality of cutter blades. When a food product is brought into contact with the rotating cutter blades, food product slices having a predetermined thicknesses and texture are created. The texturing of the slices includes crinkles or grooves formed in the slices. In such devices, the crinkles are formed as a result of a correspondingly shaped profile of the cutter blades. An example of a food product with crinkles and the cutter blade for forming the same is disclosed in U.S. Pat. No. 4,650,684 to PENROSE, the entire disclosure of this document is hereby expressly incorporated by reference.

FIGS. 1-4 show one slicer of the type described above. As can be seen in FIG. 1, the slicer includes a cutting wheel 10 to which a plurality of cutter blades 16 are secured, by way of fastener openings 18, to a hub 12 and rim 14. Each cutter blade 16 includes a leading edge 20, a trailing edge 22 and a beveled cutting portion 24. As can be seen in FIGS. 2-4, the food product FP is conveyed toward the cutting wheel 10 at a velocity V1 which causes the food product to assume velocity V2. When the food product contacts the rotating wheel 10, and specifically the area of the wheel having the blades 16, the cutter blades 16 create the slices SL as shown in FIGS. 2-4.

Since the cutter blades directly contact the food product, they wear out or lose their sharpened edge after significant use. To make such blades inexpensively, they have typically been made by a metal stamping or punching process. However, current punching or stamping processes tend to deform and stretch the sheet material, which can be particularly problematic when forming undulations or corrugations in the profile of the blade used to create crinkles in a food product. This disadvantageous deformation is evident in FIG. 5 which shows how undulations formed in current blades by stamping or punching can create areas in the undulation with thinner wall thicknesses than other areas. These thinned areas occur typically in the crests and troughs of the undulations as a result of the material in these regions being stretched. The thinner areas or regions constitute weak areas or portions WP in the undulation and have tendency to fail before the thicker portions of the blade. This is problematic because these are the very areas that perform a significant part, or even most, of the cutting. They are also believed to experience greater forces and stresses during cutting. The problem is made worse if one tries to form deeper undulations with current stamping processes, i.e., undulations with greater amplitude, so as to form deeper crinkles. Deep crinkles generally have a depth greater than 0.063 inch in amplitude. Deeper undulations, using current stamping techniques, involve more stretching and thinning of the sheet material, and thereby create even thinner and weaker areas. As a result, prior art blades have typically not utilized or been formed with deep undulations.

What is needed is a cutter blade which has undulations, and preferably deep undulations, without the weakened and/or thinned areas WP shown in FIG. 5. Ideally, as shown in FIG. 6, the undulations would have a uniform wall thickness or even slightly thicker portions TP in the regions, i.e., crests and troughs, which are typically thinned and/or weakened in blades formed by current stamping or punching techniques.

### SUMMARY OF THE INVENTION

By way of non-limiting embodiment, the invention relates to a cutter blade comprising a generally elongate member comprising an undulating portion, a leading edge, a trailing edge, and a width defined by a distance between the leading edge and the trailing edge when viewed from a first side surface. At least a section of the width of the undulating portion located behind or adjacent the leading edge having a generally uniform thickness.

In embodiments, the undulating portion comprises at least one of alternating inwardly and outwardly curved surfaces, generally circular wave crests and generally circular wave troughs, and alternating curved wave crests and curved wave troughs with no straight portions.

In embodiments, the definition of a generally uniform thickness is at least one of: a wall thickness in an area of a wave crest or a wave trough that is made to have essentially the same or greater than a wall thickness of an area where the wave crest meets the wave trough—even if the blade is at least partially formed using a stamping or material deformation process; a wall thickness in an area of a wave crest or a wave trough that is substantially the same or greater than a wall thickness of an area where the wave crest meets the wave trough; a thickness whose tolerance is less than plus or minus 0.001 inch; a thickness formed by a material removal process to a tolerance of plus or minus 0.001 inch; a thickness that has not been subjected to deformation, bending, stretching or punching during forming of the undulating portion; a thickness that does not have thinner portions caused by deformation, bending, stretching or punching during forming of the undulating portion; and a thickness that does not have substantially weakened portions caused by deformation, bending, stretching or punching during forming of the undulating portion.

In embodiments, the undulating portion does not cross or extend into a plane defined by the first side surface of the cutter blade.

In embodiments, the undulating portion comprises a pitch of about 0.333 inch.

In embodiments, the undulating portion comprises an amplitude of about 0.167 inch.

In embodiments, a radius of an inwardly curved surface of at least one undulation of the undulating portion is about 0.071 inch.

In embodiments, a radius of an outwardly curved surface of at least one undulation of the undulating portion is about 0.095 inch.

In embodiments, an overall thickness of the cutter blade is about 0.228 inch.

In embodiments, the section of the width comprises at least 5% of the width.

In embodiments, the section of the width comprises at least 10% of the width.

In embodiments, the section of the width comprises at least 25% of the width.

In embodiments, the section of the width comprises at least 50% of the width.

In embodiments, the section of the width comprises at least 75% of the width.

In embodiments, the generally elongate member further comprises at least one mounting section arranged on one side of the undulating portion.

In embodiments, the generally elongate member further comprises first and second mounting sections arranged on opposite sides of the undulating portion.

In embodiments, a length of the undulating portion is greater than 50% of an overall length of the generally elongate member.

In embodiments, a length of the undulating portion is greater than 70% of an overall length of the generally elongate member.

In embodiments, a length of the undulating portion is between about 70% and about 75% of an overall length of the generally elongate member.

In embodiments, a length of the undulating portion is between about 70% and about 75% of an overall length of the generally elongate member.

In embodiments, the undulating portion is structured and arranged to form ridges in a food product being sliced with the cutter blade.

In embodiments, the undulating portion comprises alternating outwardly curved sections and inwardly curved sections.

In embodiments, the undulating portion comprises generally equally spaced alternating outwardly curved sections and inwardly curved sections.

In embodiments, the undulating portion comprises generally circular alternating outwardly curved sections and inwardly curved sections.

In embodiments, the undulating portion comprises alternating outwardly curved sections and inwardly curved sections and a radius of each inwardly curved surface changes along the width direction.

In embodiments, the undulating portion comprises alternating outwardly curved sections and inwardly curved sections and extends to a generally planar section of the generally elongate member located between the trailing edge and the undulating portion.

In embodiments, the undulating portion comprises alternating outwardly curved sections and inwardly curved sections formed by a material removal or machining process.

In embodiments, the undulating portion comprises alternating outwardly curved sections and inwardly curved sections and each outwardly curved section has a different radius of curvature relative to an imaginary point located outside of the cutter blade.

In embodiments, the undulating portion comprises undulations and a center undulation comprises a radius of curvature of about 6.5 inches relative to an imaginary point located outside of the cutter blade.

In embodiments, the leading edge comprises a cutting edge and a length of the cutting edge viewed from the first side is between about 4 inches and about 5 inches.

In embodiments, the length of the cutting edge is about 4.6 inches.

In embodiments, the undulating portion comprises undulations having a generally uniform pitch and depth.

In embodiments, the undulating portion comprises undulations having a generally uniform pitch.

In embodiments, the undulating portion comprises undulations having a generally uniform cutting depth.

In embodiments, the undulating portion comprises a length of about 4.5 inches.

In embodiments, at least the undulating portion is formed by at least one of: a material removal or machining process; and a milling process.

In embodiments, the cutter blade is a one-piece or integrally formed member.

In embodiments, the cutter blade is made of food grade stainless steel. Alternatively, the material can be, e.g., a galvanized metal or a ceramic material, in accordance other non-limiting embodiments.

In embodiments, the cutter blade is machined from a section of material stock and the material stock is a food grade stainless steel.

In embodiments, at least the undulating portion is not subjected to anyone of: a process which shapes or deforms sheet stock; a process utilizing a punch press; and a sheet metal forming or bending process.

In embodiments, the cutter blade is not subjected to anyone of a process which shapes or deforms sheet stock; a process utilizing a punch press; and a sheet metal forming or bending process.

In embodiments, the leading edge is straight when viewed from the first side of the cutter blade.

In embodiments, the trailing edge is straight when viewed from the first side of the cutter blade.

In embodiments, the leading edge and the trailing edge are parallel to one another when viewed from the first side of the cutter blade.

In embodiments, the generally elongate member comprises oppositely arranged mounting ends.

In embodiments, each mounting end comprises a through opening.

In embodiments, each through opening is sized and configured to receive therein a blade retaining fastener.

In embodiments, the generally elongate member is capable of being tensioned and/or resists tensioning along a direction of a length of the generally elongate member.

In embodiments, a length of the generally elongate member is greater than three times the width and the width is greater than three times an overall thickness of the cutter blade.

In embodiments, a length of the leading edge is different from a length of the trailing edge when viewed from the first side of the cutter blade.

In embodiments, the length of the leading edge is greater than the length of the trailing edge.

In embodiments, the leading edge of all undulations of the undulating portion comprise a cutting edge.

In embodiments, the leading edge comprises one of: a beveled edge; a tapered edge; and a sharpened cutting edge.

In embodiments, the cutter blade is mountable at least one of: on a rotary cutting wheel adapted to slice food products; on a rotating device and in a generally radial orientation; on a rotating device so that a cutting edge of the cutter blade faces a direction of rotation and the cutter blade is oriented generally parallel to an annular surface of the rotating device; and on a rotating device having inner and outer annular mounting surfaces and so that a cutting edge of the cutter blade faces a direction of rotation.

By way of non-limiting example, the invention also relates to a method of slicing a food product, wherein the method comprises mounting at least one cutter blade of any of the types described above on a device that rotates and rotating the at least one cutter about a center axis of the device that rotates.

In embodiments, the method may further comprise moving the food product into contact with the rotating cutter blade so that uniform thickness slices of the food product are formed.

In embodiments, the method may further comprise moving the food product into contact with the rotating cutter blade so that slices of the food product are formed with ridges, grooves or crinkles.

In embodiments, the method may further comprise moving the food product into contact with the rotating cutter blade so that slices of the food product are formed with generally circular ridges, generally circular grooves or generally circle crinkles.

In embodiments, the method may further comprise moving the food product into contact with the rotating cutter blade so that slices of the food product are formed with grooves or crinkles deeper than 0.080 inch.

In embodiments, the method may further comprise moving the food product into contact with the rotating cutter blade so that slices of the food product are formed with grooves or crinkles deeper than 0.1 inch.

In embodiments, the method may further comprise moving the food product into contact with the rotating cutter blade so that slices of the food product are formed with grooves or crinkles deeper than 0.15 inch.

In embodiments, the method may further comprise moving the food product into contact with the rotating cutter blade so that slices of the food product are formed with grooves or crinkles having a depth of about 0.167 inch.

In embodiments, the food product is at least one of a vegetable and a fruit.

In embodiments, the food product is at least one of: a potato; a pickle; a carrot; a zucchini; and a generally elongate vegetable.

By way of non-limiting example, the invention also relates to a method of assembling a device for slicing a food product, wherein the method comprises mounting or removably mounting at least one cutter blade of the type described above on a rotating portion of the device.

By way of non-limiting example, the invention also relates to a cutter blade comprising a generally elongate member comprising an undulating portion, a leading edge, a trailing edge, a width defined by a distance between the leading edge and the trailing edge when viewed from a first side surface, and a length measured perpendicular to the width. At least one undulation of the undulating portion includes a radius of curvature relative to an imaginary center point located outside the cutter blade. At least a section of the width of the undulating portion located directly behind the leading edge at least one of: has a generally uniform thickness, is formed by a material removal process, and is not subjected to deformation, bending or stretching when formed.

By way of non-limiting example, the invention also relates to a cutter blade for producing crinkle slices comprising a generally elongate member comprising an undulating portion, a leading edge, a trailing edge, a width defined by a distance between the leading edge and the trailing edge when viewed from a first side surface, and a length measured perpendicular to the width. The undulating portion is located entirely on one side of an imaginary plane defined by the first side. At least a substantial part of the undulating portion being formed by a material removal process. At least one undulation of the undulating portion has a radius of curvature relative to an imaginary center point located outside the cutter blade. At least a section of the width of the undulating portion located behind the leading edge has a uniform thickness.

In embodiments, the cutter blade of the invention can be used on any conventional slicers including those described herein.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a conventional slicer cutting wheel having a plurality of radially oriented cutter blades for slicing food products;

FIG. 2 shows a side view of a conventional slicer cutting wheel in relation to a food product about to be sliced and being conveyed toward the cutting wheel;

FIG. 3 shows an end view of FIG. 3;

FIG. 4 shows an enlarged view of a portion of the apparatus shown in FIG. 2 and illustrates how a food product is sliced;

FIG. 5 shows a conventional blade cutter undulation portion and illustrates how certain portions of the undulation have relatively thinned wall thickness zones or areas due to the blade cutter being formed by punching or material bending, thereby creating weak areas;

FIG. 6 shows an improved blade cutter undulation portion in accordance with the invention and illustrates an idealized way to make the portions of the undulation (which have relatively thinned wall thickness zones or areas in the conventional blade) having relatively thicker wall thickness in the same areas. To form such an ideal configuration, the blade cutter should not be formed by punching or material bending, and can be formed instead by a material removal process;

FIG. 7 shows a top side view of a blade cutter in accordance with the invention and utilizing an undulation section which does not have thinned wall thickness zones or areas as shown in FIG. 5;

FIG. 8 shows a cross-section through the center of the blade cutter shown in FIG. 7;

FIG. 9 schematically shows a front view of the blade cutter shown in FIG. 7;

FIG. 10 shows an enlarged portion of FIG. 9 labeled as Detail A and prior to sharpening the cutting edge portion of the leading edge;

FIG. 11 shows a bottom side view of a blade cutter of FIG. 7;

FIG. 12 shows the cutter blade of FIG. 7 in relation to an imaginary center rotation point in space;

FIG. 13 shows a perspective view of the cutter blade of FIG. 7;

FIGS. 14 and 15 shows enlarged portions of the cutting edge portion of the cutter blade of FIG. 7; and

FIG. 16 shows a cross-section through the blade cutter and illustrating an angle of the tapered cutting edge.

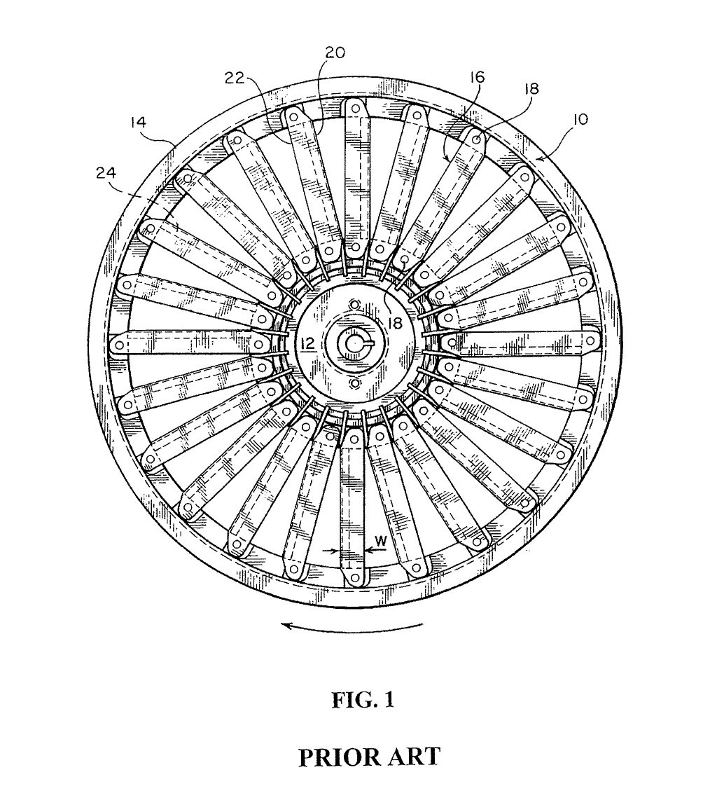

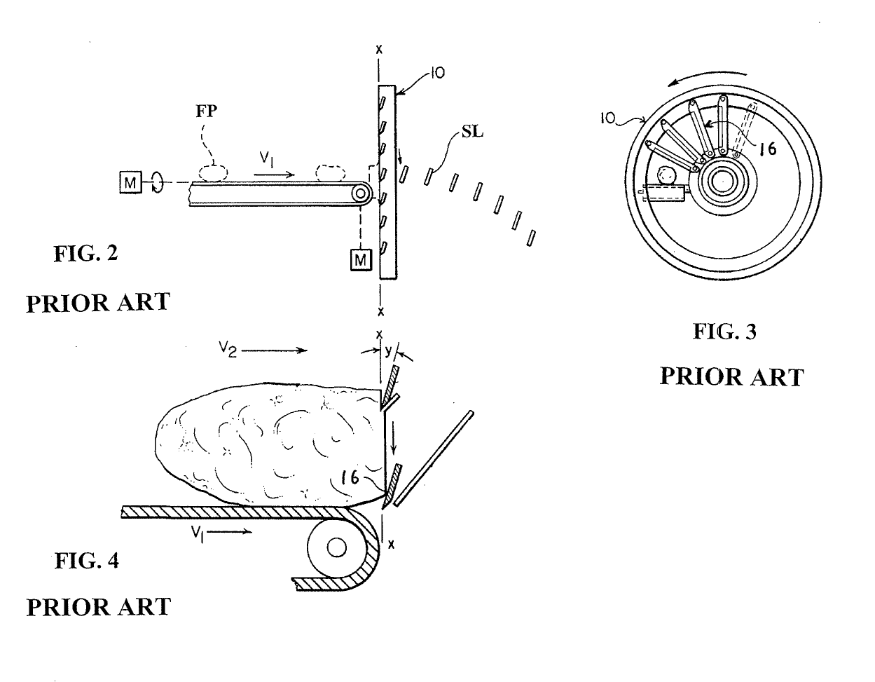

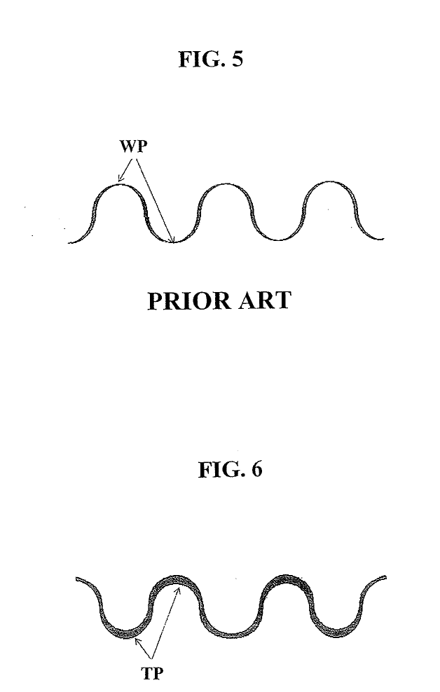

### DETAILED DESCRIPTION OF THE INVENTION

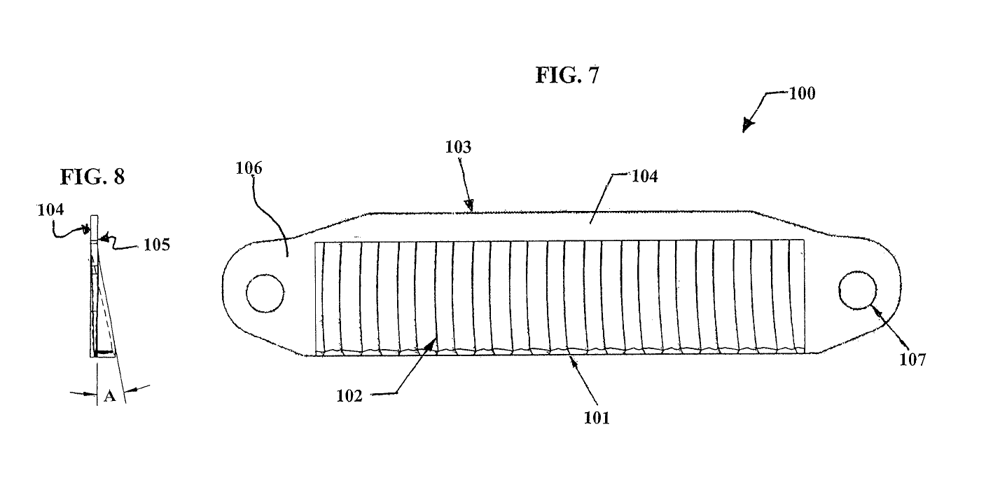

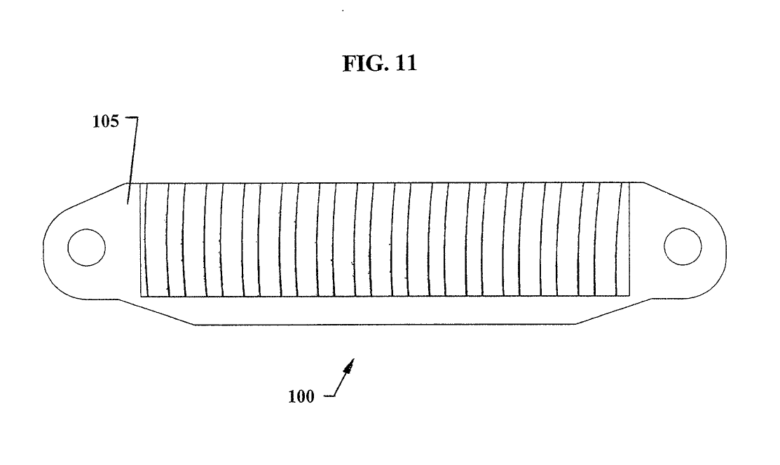

FIGS. 7-16 show a first non-limiting embodiment of the invention. In FIGS. 7, 8, 11 and 13, a blade cutter 100 is shown having a leading edge 101 which is generally straight when view from the upper side, an undulation or undulating section 102 extending to the leading edge 101, a trailing edge 103 which can be generally parallel to the leading edge 101, a first or upper side 104 and a second or lower side 105. The blade member 100 also includes oppositely arranged mounting end portions 106 which each have a through opening 107 sized to receive therein a fastener. The undulation section 102 increases in depth or thickness from the direction of trailing edge 103 toward the leading edge 101 as shown in FIG. 8. Each undulating section of the undulation 102 can have a radius of curvature with the center undulation having the radius 116 as shown in FIG. 11.

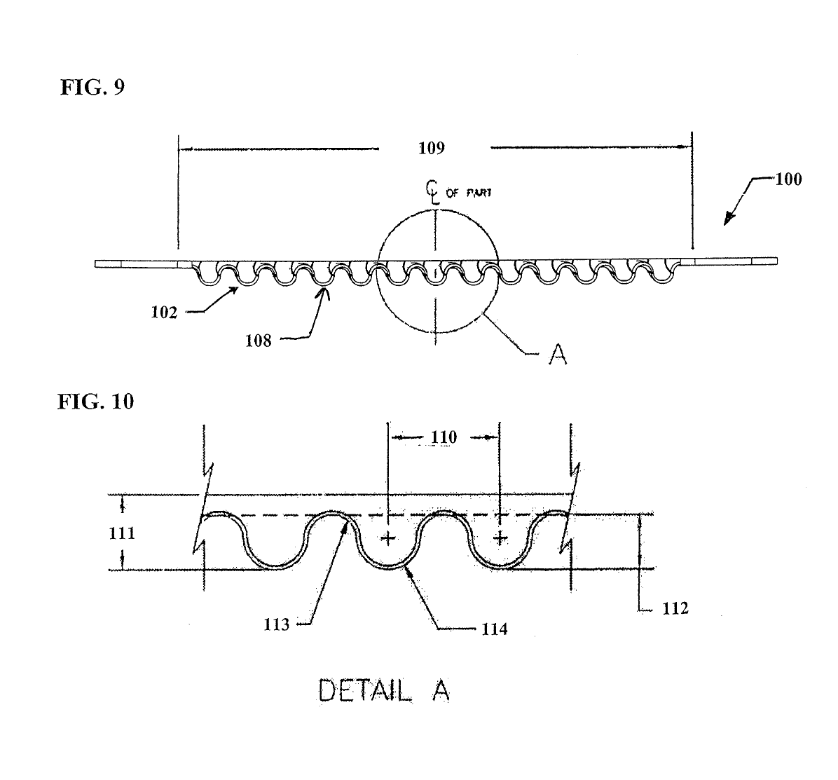

In FIGS. 9 and 10, it can be seen that the undulation or undulating section 102 forms a cutting portion 108 of the blade cutter 100 having a predetermined cutting length 109. It is this cutting profile 108 which forms the grooves in the food product being sliced. With the blade member 100 of the invention, however, one can achieve deeper grooves in the food product while at the same time ensuring that the blade cutter life is not shortened to an uneconomic level. Thus, for example, the undulating section 102 can have be formed of generally uniform alternating inwardly and an outwardly curved sections having a generally uniform pitch 110, defining a maximum thickness 111 of the blade cutter 100, and defining a depth of groove in the food product determined by dimension 112. Each inwardly curved section of the undulating section 102 has a radius 113 and each outwardly curved section of the undulating section 102 has a radius 114.

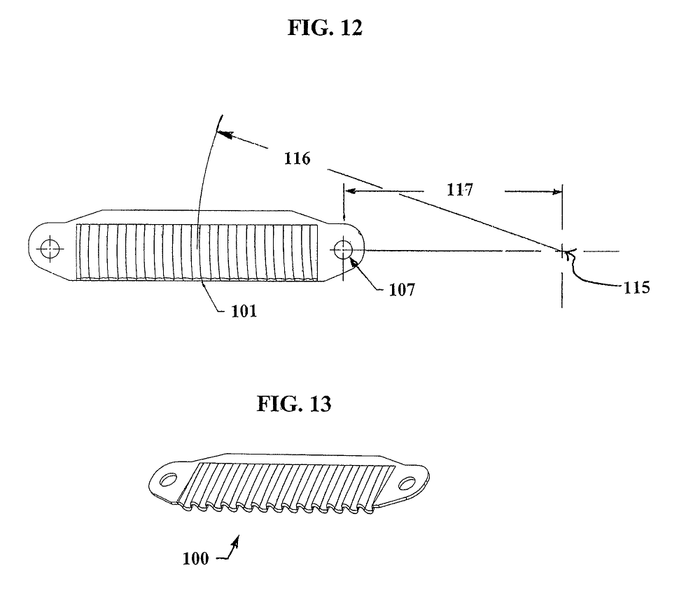

In FIG. 12, it can be seen how the blade cutter 100 can be mounted so as to rotate about a rotation point 115 such that distance from the center point 115 and one opening 107 has the dimension 117 and with the distance from the center point 115 and a center of the undulating portion has the dimension 116.

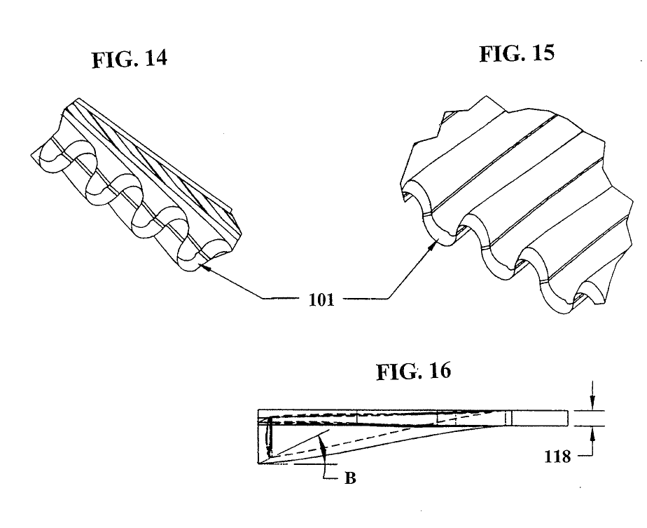

In FIGS. 14-16 it can be seen how cutting portion of the leading edge 101 of the blade cutter 100 can be tapered to a sharp edge so that it utilizes an angle B. The leading edge 101 can preferably be sharpened by grinding.

### Example 1

According to one non-limiting embodiment of the invention, the values (in inches) are as follows:

Angle A is approximately 11 degrees;

Angle B is approximately 26 degrees;

Overall length is approximately 6.006 inches;

Overall width is approximately 1.25 inches;

Overall width of undulating section is approximately 1.00 inches;

Overall length of undulating section is approximately 4.3125 inches;

Reference 107 is approximately 0.326 inch;

Distance between centers of openings 107 is approximately 5.25 inches;

Reference 109 is approximately 4.5625 inches;

Reference 110 is approximately 0.333 inch;

Reference 111 is approximately 0.219 to approximately 0.228 inch;

Reference 112 is approximately 0.167 inch to approximately 0.191 inch;

Reference 113 is approximately 0.071 inch;

Reference 114 is approximately 0.095 inch;

Reference 116 is approximately 6.515 inches;

Reference 117 is approximately 3.890 inches; and

Thickness 118 between surfaces 104 and 105 is approximately 0.0605 inches;

Wall thickness of the undulating wall behind the tapered cutting edge is approximately 0.19 inch.

### Example 2

According to one non-limiting embodiment of the invention, the invention relates to a cutter blade 100 comprising a generally elongate member comprising an undulating portion 102, a leading edge 101, a trailing edge 103, and a width defined by a distance between the leading edge 101 and the trailing edge 103 when viewed from a first side surface 104. At least a section of the width of the undulating portion 102 located behind or adjacent the leading edge 101 having a generally uniform thickness.

### Example 3

According to one non-limiting embodiment of the invention, the invention relates to a cutter blade 100 comprising a generally elongate member comprising an undulating portion 102, a leading edge 101, a trailing edge 103, a width defined by a distance between the leading edge 101 and the trailing edge 103 when viewed from a first side surface 104, and a length measured perpendicular to the width. At least one undulation of the undulating portion 102 includes a radius of curvature 116 relative to an imaginary center point 115 located outside the cutter blade 100. At least a section of the width of the undulating portion 102 located directly behind the leading edge 101 at least one of: has a generally uniform thickness, is formed by a material removal process, and is not subjected to deformation, bending or stretching when formed.

### Example 4

By way of non-limiting example, the invention also relates to a cutter blade 100 for producing crinkle slices comprising a generally elongate member comprising an undulating portion 102, a leading edge 101, a trailing edge 103, a width defined by a distance between the leading edge 101 and the trailing edge 103 when viewed from a first side surface 104, and a length measured perpendicular to the width. The undulating portion 102 is located entirely on one side of an imaginary plane defined by the first side 104. At least a substantial part of the undulating portion 102 being formed by a material removal process. At least one undulation of the undulating portion 102 has a radius of curvature 116 relative to an imaginary center point 115 located outside the cutter blade 100. At least a section of the width of the undulating portion 102 located behind the leading edge 101 has a uniform thickness.

### Example 5

In embodiments, the cutter blade 100 is mountable at least one of: on a rotary cutting wheel 10 adapted to slice food products, on a rotating device 10 and in a generally radial orientation, on a rotating device 10 so that a cutting edge 108 of the cutter blade 100 faces a direction of rotation and the cutter blade 100 is oriented generally parallel to an annular surface of the rotating device 10, and on a rotating device 10 having inner and outer annular mounting surfaces and so that a cutting edge 108 of the cutter blade 100 faces a direction of rotation.

### Example 6

In embodiments, the invention also relates to a method of slicing a food product FP, wherein the method comprises mounting at least one cutter blade 100 of any of the types described above on a device 10 that rotates and rotating the at least one cutter blade 100 about a center axis of the device 10 that rotates. The method may further comprise moving the food product FP into contact with the rotating cutter blade 100 so that uniform thickness slices of the food product are formed. The method may also further comprise moving the food product FP into contact with the rotating cutter blade 100 so that slices of the food product are formed with ridges, grooves or crinkles. The method may also further comprise moving the food product FP into contact with the rotating cutter blade 100 so that slices of the food product are formed with generally circular ridges, generally circular grooves or generally circle crinkles. The method may also further comprise moving the food product FP into contact with the rotating cutter blade 100 so that slices of the food product FP are formed with grooves or crinkles deeper than 0.080 inch. The method may further comprise moving the food product FP into contact with the rotating cutter blade 100 so that slices of the food product FP are formed with grooves or crinkles deeper than 0.1 inch. The method may also further comprise moving the food product FP into contact with the rotating cutter blade 100 so that slices of the food product FP are formed with grooves or crinkles deeper than 0.15 inch. The method may also further comprise moving the food product FP into contact with the rotating cutter blade 100 so that slices of the food product FP are formed with grooves or crinkles having a depth of about 0.167 inch.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A cutter blade comprising:
a generally elongate member comprising an undulating portion, a leading edge, a trailing edge, and a width defined by a distance between the leading edge and the trailing edge when viewed from a first side surface; and
at least a section of the width of the undulating portion located behind or adjacent the leading edge having a generally uniform thickness.

2. The cutter blade of claim 1, wherein the undulating portion does not cross or extend into a plane defined by the first side surface of the cutter blade.

3. The cutter blade of claim 1, wherein the undulating portion comprises a pitch of about 0.333 inch and an amplitude of about 0.167 inch.

4. The cutter blade of claim 1, wherein a radius of an inwardly curved surface of at least one undulation of the undulating portion is about 0.071 inch and a radius of an outwardly curved surface of at least one undulation of the undulating portion is about 0.095 inch.

5. The cutter blade of claim 1, wherein an overall thickness of the cutter blade is between about 0.219 and about 0.228 inch.

6. The cutter blade of claim 1, wherein the section of the width comprises at least 10% of the width.

7. The cutter blade of claim 1, wherein the section of the width comprises at least about 65% to about 75% of the width.

8. The cutter blade of claim 1, wherein the generally elongate member further comprises at least one mounting section arranged on one side of the undulating portion.

9. The cutter blade of claim 1, wherein the undulating portion is structured and arranged to form ridges in a food product being sliced with the cutter blade.

10. The cutter blade of claim 1, wherein the undulating portion comprises at least one of:
alternating outwardly curved sections and inwardly curved sections; and
undulations having a generally uniform pitch and depth.

11. The cutter blade of claim 1, wherein the leading edge comprises a cutting edge and a length of the cutting edge viewed from the first side is between about 4 inches and about 5 inches.

12. The cutter blade of claim 1, wherein the cutter blade is configured to form potato slices having crinkles or grooves.

13. The cutter blade of claim 1, wherein at least the undulating portion is formed by at least one of:
a material removal or machining process; and
a milling process.

14. The cutter blade of claim 1, wherein the cutter blade is at least one of:
made of food grade stainless steel; and
machined from a section of material stock and the material stock is a food grade stainless steel.

15. The cutter blade of claim 1, wherein at least the undulating portion is not subjected to anyone of:
a process which shapes or deforms sheet stock;
a process utilizing a punch press; and
a sheet metal forming or bending process.

16. The cutter blade of claim 1, wherein the leading edge comprises one of:
a beveled edge;
a tapered edge; and
a sharpened cutting edge.

17. The cutter blade of claim 1, wherein the cutter blade is mountable on at least one of:
a rotary cutting wheel adapted to slice food products;
a rotating device and in a generally radial orientation;
a rotating device so that a cutting edge of the cutter blade faces a direction of rotation and the cutter blade is oriented generally parallel to an annular surface of the rotating device; and
a rotating device having inner and outer annular mounting surfaces and so that a cutting edge of the cutter blade faces a direction of rotation.

18. A method of cutting or slicing a food product, the method comprising:
mounting at least one cutter blade of claim 1 on a device that rotates; and
rotating the at least one cutter about a center axis of the device that rotates.

19. A cutter blade comprising:
a generally elongate member comprising an undulating portion, a leading edge, a trailing edge, a width defined by a distance between the leading edge and the trailing edge when viewed from a first side surface, and a length measured perpendicular to the width;
at least one undulation of the undulating portion having a radius of curvature relative to an imaginary center point located outside the cutter blade; and
at least a section of the width of the undulating portion located directly behind the leading edge at least one of:
having a generally uniform thickness;
being formed by a material removal process; and
not being subjected to deformation, bending or stretching when formed.

20. A cutter blade for producing crinkle slices comprising:
a generally elongate member comprising an undulating portion, a leading edge, a trailing edge, a width defined by a distance between the leading edge and the trailing edge when viewed from a first side surface, and a length measured perpendicular to the width;
the undulating portion being located entirely on one side of an imaginary plane defined by the first side;
at least a substantial part of the undulating portion being formed by a material removal process;
at least one undulation of the undulating portion having a radius of curvature relative to an imaginary center point located outside the cutter blade; and
at least a section of the width of the undulating portion located behind the leading edge having a uniform thickness.
